(19) United States
(12) Patent Application Publication
(10) Pub. No.: US 2009/0110325 A1
(43) Pub. Date: Apr. 30, 2009

(54) Image sensor with pixel array subset sampling

(76) Inventors: Lyle R. Smith, Puyallup, WA (US); Jesse J. Kolstad, Fife, WA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/981,917

(22) Filed: Oct. 31, 2007

(51) Int. Cl. G06K 9/40

(52) U.S. Cl. 382/275

(57) ABSTRACT

An apparatus comprising a pixel array to capture an image of a symbol code, wherein the image is formed on a plurality of pixels within the pixel array and is moving relative to the pixel array, and circuitry and logic coupled to the pixel array to sample a subset of pixels at a selected sampling rate, wherein the subset comprises at least one pixel from among the plurality of pixels on which the image is formed. A process comprising forming an image of a symbol code on a pixel array, wherein the image is formed on a plurality of pixels within the pixel array and is moving relative to the pixel array, and sampling a subset of pixels at a selected sampling rate, wherein the subset comprises at least one pixel from among the plurality of pixels on which the image is formed.

### TECHNICAL FIELD

The present invention relates generally to machine-vision cameras and systems and in particular, but not exclusively, to machine vision cameras and systems with image sensors employing pixel array subset sampling.

### BACKGROUND

Optical data-reading devices have become an important and ubiquitous tool in tracking many different types of items. Optical data-reading devices read some form of optical symbol that has information encoded in it and extract the encoded information. The type of optical data-reading device used often depends on the type of optical symbol being used, although some optical data reading devices can read various types of symbols. Bar code scanners typically read and decode linear bar codes, the most familiar type of which usually consists of a series of black bars of differing widths spaced apart from each other by white space. Machine vision systems are most commonly used to read and decode two-dimensional codes (also known as “matrix” codes), but are capable of reading and decoding virtually any kind of symbol, including linear bar codes.

Machine vision systems capture a two-dimensional digital image of the optical symbol and then proceed to analyze that image to extract the information contained in the optical symbol. One difficulty that has emerged in machine vision systems is that of ensuring that the machine vision camera acquires a complete image of the optical symbol from which it can extract information; if the machine vision camera cannot capture a complete image of the symbol code, the machine vision system will be unable to decode the optical symbol because there will be missing information.

One of the difficulties in acquiring a complete image is ensuring that the code itself is positioned within the field of view of the camera. Problems can arise whenever the optical symbol is too big for the field of view, is moving relative to the camera, or both. In some cases these problems can be solved with steps such as adjusting the optics in the camera or varying the distance between the camera and the optical symbol, but in other cases other techniques are needed to allow the machine vision camera to still gather the information it needs so that it can read and decode an optical symbol.

### BRIEF DESCRIPTION OF THE DRAWINGS

Non-limiting and non-exhaustive embodiments of the present invention are described with reference to the following figures, in which like reference numerals refer to like parts throughout the various views unless otherwise specified. Drawings are not to scale unless specifically indicated.

FIG. 1A is a schematic drawing of an embodiment of an imaging camera reading an optical symbol fully contained within its field of view.

FIG. 1B is a schematic drawing of an embodiment of an imaging camera reading an optical symbol not fully contained within its field of view.

FIG. 2A is a schematic drawing of an embodiment of an imaging camera reading an optical symbol moving relative to the imaging camera.

FIG. 2B is a schematic drawing of an embodiment of an image formed on a pixel array within an imaging camera by an optical symbol moving relative to the imaging camera.

FIG. 3A is a schematic drawing of an embodiment of an image formed on a subset of pixels in a pixel array within an imaging camera by an optical symbol moving relative to the imaging camera.

FIG. 3B is a graph showing an embodiment of signals resulting from sampling the subset of pixels shown in FIG. 3A.

FIGS. 4A-4D illustrate different embodiments of the subset of pixels shown in FIGS. 3A-3B.

FIG. 5 is a schematic drawing of an embodiment of a symbol-reading system for reading an optical symbol moving relative to the symbol-reading system.

FIG. 6A is a schematic drawing of an embodiment of an imaging camera reading multiple optical symbols that are moving relative to the imaging camera.

FIG. 6B is a schematic drawing of an embodiment of an image formed on a pixel array within an imaging camera by multiple optical symbols that are moving relative to the imaging camera.

FIG. 7 is a schematic drawing of an embodiment of an image formed on a subset of pixels in a pixel array within an imaging camera by multiple optical symbols that are moving relative to the imaging camera.

FIG. 8 is a schematic drawing of an alternative embodiment of an image formed on a subset of pixels in a pixel array within an imaging camera by multiple optical symbols moving relative to the imaging camera.

### DETAILED DESCRIPTION OF THE ILLUSTRATED EMBODIMENTS

Embodiments of an apparatus, system and method for line processing using an image sensor are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

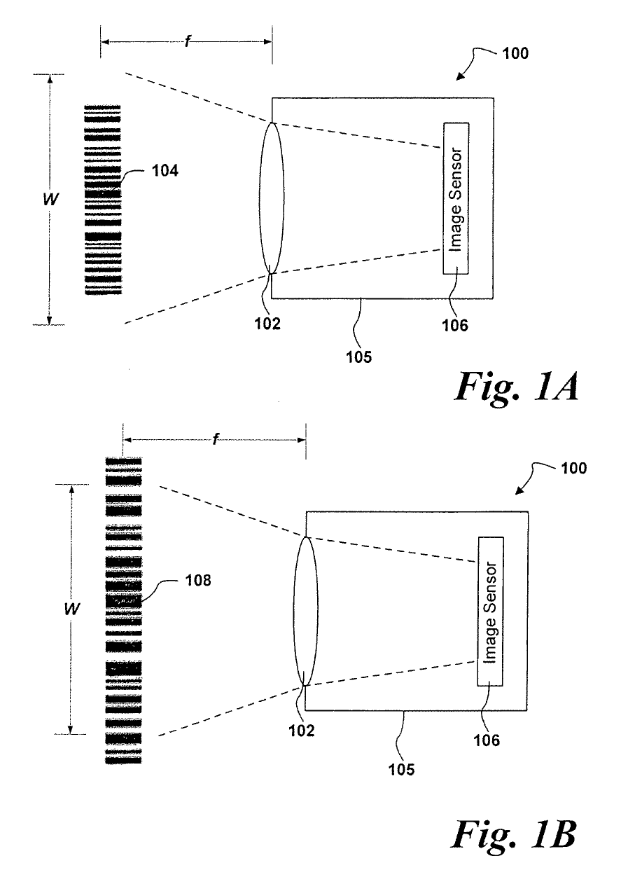

FIG. 1A illustrates an embodiment of an imaging camera 100 that can be used to capture images of symbol codes. Imaging cameras such as camera 100 are most often used in machine-vision systems to capture images of two-dimensional bar codes (also referred to as “matrix codes”), but can also be used with other types of optical symbols such as linear bar codes. Imaging camera 100 includes an optical element 102 at an opening in a housing 105 and also includes an image sensor 106 within housing 105. Image sensor 106 is optically coupled to optical element 102 by positioning image sensor 106 relative to optical element 102 such that the optical element forms an image of an optical symbol such as bar code 104 on the image sensor.

Optical element 102 has a focal length f at which the width of its field of view, and thus the field of view of imaging camera 100, is W. In the embodiment shown, bar code 104 has a width less than or equal to W, and thus the bar code fits within the field of view of the imaging camera. Because imaging camera 100 relies on image capture, it can decode an image of any kind of optical symbol, provided at least one complete image of the optical symbol can be captured. Under the circumstances shown in the figure, image sensor 106 can capture an image of the entire bar code 104 and that image can then be analyzed and decoded to extract the information encoded in bar code 104.

FIG. 1B illustrates an embodiment in which imaging camera 100 is used to attempt to capture an image of a bar code 108 that is wider than the camera's field of view. In this embodiment, the width of bar code 108 is greater than the width W of the field of view of imaging camera 100. As a result, image sensor 106 will be unable to capture a complete image of bar code 108 because, with bar code 108 positioned as shown in the drawing, its edges will be missing from the image. Because the image of bar code 108 captured by image sensor 106 will be incomplete, part of the information encoded in the bar code will be missing and the image can no longer be analyzed and decoded to correctly extract the encoded information.

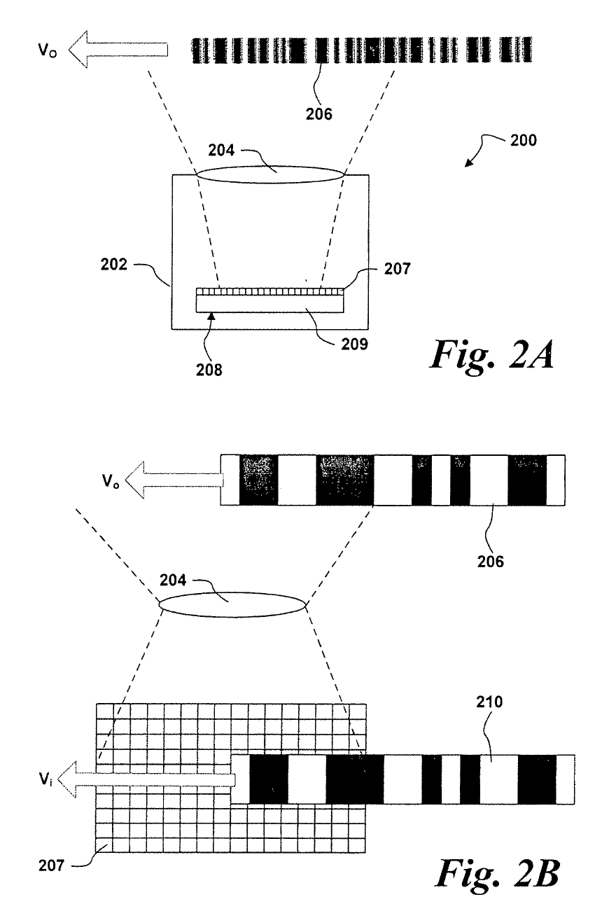

FIGS. 2A-2B together illustrate an embodiment of an imaging camera 200 that can use movement of an optical symbol relative to the camera to capture and analyze optical symbols, such as bar code 206, that do not fit within the camera's field of view. FIG. 2A illustrates an imaging camera 200 including a housing 202 within which an image sensor 208 is housed. Housing 202 includes an opening within which an optical element 204 is positioned and aligned such that it projects an image of objects within its field of view onto image sensor 208. An optical symbol such as bar code 206 moves through the field of view of optical element 204 with a speed V_{O}, such that optical element 204 projects an image of moving bar code 206 onto image sensor 208 (see FIG. 2B, below).

Image sensor 208 is used to receive the light focused on it by optical element 204 and to capture an image of one or more objects within the field of view of optical element 204. Image sensor 208 includes a pixel array 207 that captures images. During operation of pixel array 207, each pixel in the array captures incident light (i.e., photons) during a certain exposure period and converts the collected photons into an electrical charge. The electrical charge generated by each pixel can be read out as an analog signal, and a characteristic of the analog signal such as its charge, voltage or current will be representative of the intensity of light that was incident on the pixel during the exposure period. In addition to pixel array 207, image sensor 208 can include circuitry and logic 209 coupled to pixel array 207 to perform support functions for the pixel array, such as implementing a pixel reading scheme, conditioning signals received from pixels within pixel array 207, and so forth.

The illustrated pixel array 207 is two-dimensional and regularly shaped, but in other embodiments the pixel array can have a regular or irregular arrangement different than shown and can include more or less pixels, rows and columns than shown. Moreover, in different embodiments pixel array 207 can be a color image sensor including red, green and blue pixels (i.e., an RGB image sensor) or cyan, magenta and yellow pixels (i.e., a CMY image sensor) designed to capture color images in the visible portion of the spectrum, can be a black-and-white image sensor designed to capture images in the visible portion of the spectrum, or can be an image sensor designed to capture images in invisible portions of the spectrum such as infra-red or ultraviolet.

Optical element 204 is positioned on the end of housing 202 facing the object whose image is to be captured. Although shown in the illustrated embodiment as a single optical component at a fixed distance from image sensor 208, in other embodiments optical element 204 can have multiple components and its distance from image sensor 208 can be varied manually or can be varied automatically, for example with a focus control system. Moreover, in different embodiments optical element 204 can be a refractive optical element, a reflective optical element, a diffractive optical element, or combinations of all or some of these.

FIG. 2B illustrates how optical element 204 projects an image of bar code 206 onto pixel array 207. As bar code 206 moves with speed V_{O} through the field of view of optical element 204, the optical element projects an image 210 of bar code 206 onto a plurality of the individual pixels within pixel array 207. Image 210 moves across pixel array 207 with a speed V_{I} that can depend on various factors, such as the speed V_{O} of bar code 206 and the exact nature of optical element 204. Although bar code 206 and its image 210 are shown in the figure as moving in the same direction, in other embodiments bar code 206 and its image 210 can move in different directions, depending on factors such as the characteristics of optical element 204.

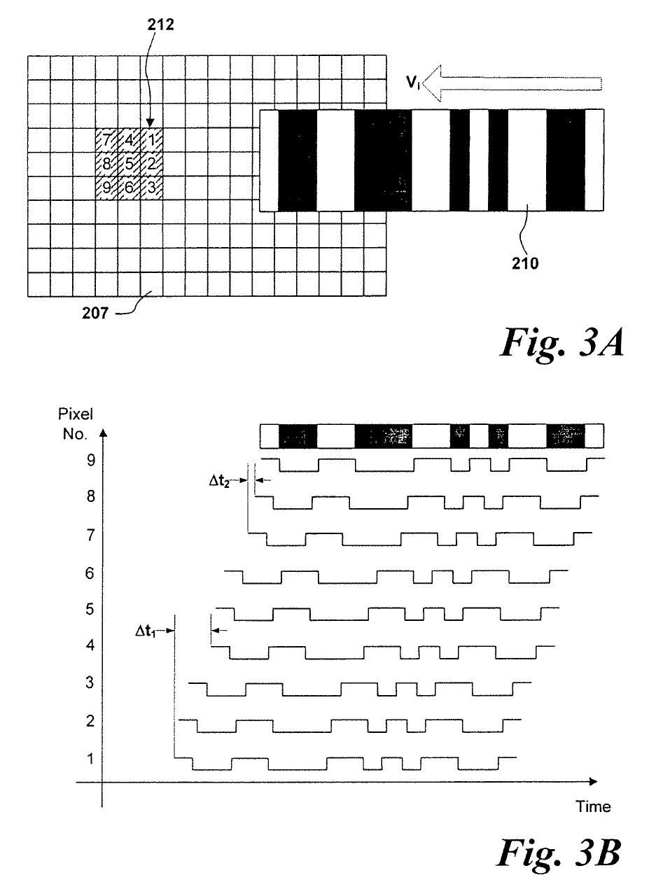

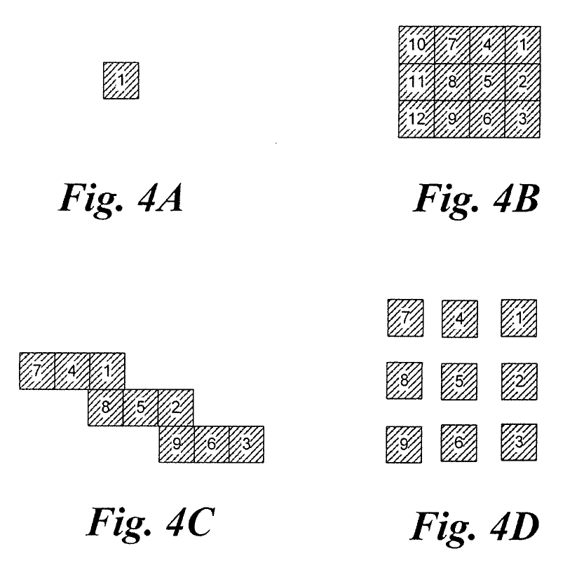

FIG. 3A illustrates an embodiment of image 210 passing over pixel array 207. As image 210 moves across a plurality of pixels on pixel array 207 with speed V_{I}, it will move across a subset of pixels 212 within the plurality of pixels on which image 210 is formed. Pixel subset 212 is shown in the figure as a square 3-by-3 array with nine pixels numbered 1-9, but in other embodiments a square pixel array with different dimensions and a different total number of pixels can be used. Furthermore, as described below in connection with FIGS. 4A-4D, in other embodiments different configurations of pixels can be used to form the subset 212.

As image 210 moves over subset 212, each of pixels 1-9 in the subset 112 can be sampled at a specified rate to capture the information within image 210. The sampling rate selected for sampling signals from each pixel in subset 212 will depend on various factors. First is the pixel-reading scheme used by image sensor 208 to extract information from the individual pixels in pixel array 207. In one embodiment, image sensor 208 can use a rolling shutter scheme in which pixels in the array are read in column-by-column order or row-by-row order. Using a rolling shutter scheme can limit the sampling rate of pixels 1-9 within subset 212, because after sampling the three rows and/or columns in which subset 212 is located the image sensor must cycle through all the other rows/columns in pixel array 207 before returning to the three rows and/or columns in which subset 212 is located. In a different embodiment in which image sensor 208 includes a pixel array 207 with individually addressable pixels, the selected sampling rate can be much faster since the sensor need only read the pixels within subset 212 and not any of the remaining pixels in the array.

Second, the specified sampling rate can be determined by the speed V_{O} of bar code 206 relative to the imaging camera 200 and the corresponding speed V_{I} of image 210 relative to pixel array 207; as a general rule, an embodiment with a higher speed V_{I} will require a higher sampling rate. The specified sampling rate can also be determined by how constant V_{O} and V_{I} are; in an embodiment where V_{O}, and consequently V_{I}, is not very constant (i.e., both are very variable or unsteady), a higher sampling rate will be needed than in an embodiment where V_{O} and V_{I} are more constant. Third, characteristics of bar code 206 can determine the specified sampling rate. If bar code 206 contains very narrow elements (black bars and/or white spaces between bars) a higher sampling rate will be needed to capture the high-frequency black-to-white or white-to-black transitions associated with narrow bar-code elements. Finally, other factors not listed here, such as lighting conditions, can also affect the selected sampling rate. In one embodiment every pixel in subset 212 can be sampled at the same rate, but in other embodiments the pixels in subset 212 can be sampled at different rates.

FIG. 3B is a graph illustrating an embodiment the signals produced as a result of sampling pixels 1-9 image 210 passes over subset 212. Bar code image 210 is reproduced above the signal corresponding to pixel 9 to illustrate the correspondence between the image 210 and the resulting signal. As image 210 moves over subset 212, each pixel 1-9, when sampled, can record a high value corresponding to a white portion of image 210 or a low value corresponding to a black portion of image 210. Using the high and low values sampled by each pixel 1-9 and information about the sampling rate, an analog or digital signal corresponding to image 210—and thus to bar code 206—can be constructed as shown in the figure and later decoded to extract the information encoded in bar code 206. Capturing multiple signals using multiple pixels creates redundant signals that can be used for error checking, correction, or other purposes.

In the group of signals shown in the figure, each signal is slightly offset by a time Δt₂ from the previous signal because of the time between sampling one pixel and the next; thus, the signal from pixel 8 is slightly offset from the signal from pixel 7 by time Δt₂. Similarly, the signal from a given pixel will be offset by a time Δt₁ from the signal of the corresponding pixel in the previous column because of the time it takes image sensor 208 to cycle through other pixels in each column; thus, the signal of pixel 4 is offset from the signal of pixel 1 by time Δt₁. The values of Δt₁ and Δt₂ will depend on factors such as the pixel reading scheme employed by image sensor 208; in an embodiment where image sensor 208 uses a rolling shutter, the values of Δt₁ and Δt₂ will be relatively high, but in an embodiment with individually addressable pixels the values of Δt₁ and Δt₂ will be substantially smaller, in some cases so small they may be negligible.

FIGS. 4A-4D illustrate various embodiments of the subset of pixels 212 that can be sampled as image 210 of bar code 206 moves across pixel array 207. FIG. 4A illustrates an embodiment of subset 212 that is a single pixel. Subset 212 can include a single pixel in cases where higher speed (i.e., a faster sampling rate) is desired, but where redundant signals are not needed for error checking and correction. The single-pixel configuration can be used when the alignment of bar code 206 and its direction of travel guarantee that at least part of its image 210 will pass over the single pixel. FIG. 4B illustrates an embodiment of subset 212 that is a rectangular 4-by-3 pixel array with 12 pixels, but in other embodiments M-by-N rectangular pixel arrays with different dimensions and more or less total pixels can be used. In different embodiments of a rectangular M-by-N subset, M and N each can vary between 1 and 1000. FIG. 4C illustrates an embodiment of subset 212 that is made up of three staggered rows of three pixels each, for a total of nine pixels. In other embodiments, a different number of rows, a different number of pixels per row, and a different stagger configuration such as non-contiguous rows can be used. FIG. 4D illustrates an embodiment of subset 212 that is a 3-by-3 square pixel array with pixels 1-9, but in this embodiment the pixels in subset are not contiguous but instead are separated from each other by at least one pixel. In other embodiments, pixel arrays with different dimensions and a different total number of pixels can be used. Moreover, although FIG. 4D shows uniformly spacing between pixels 1-9, in different embodiments the spacing between pixels need not be uniform.

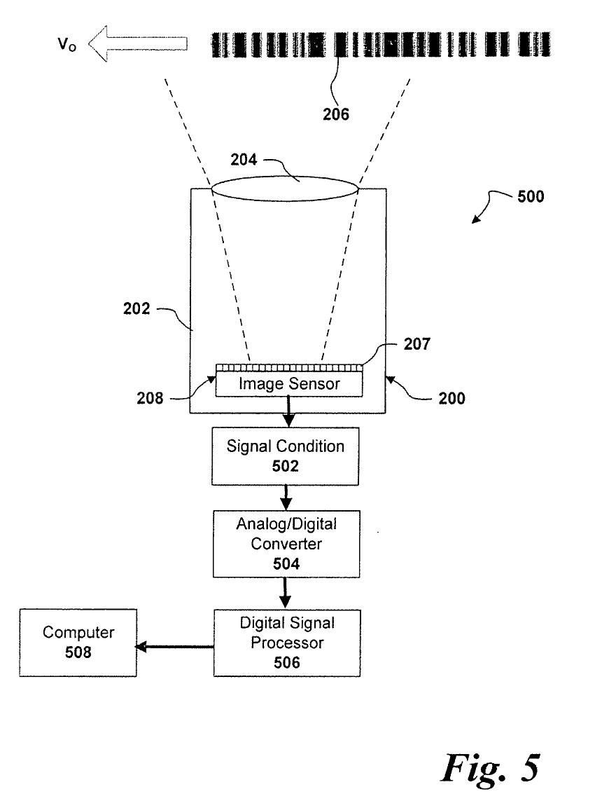

FIG. 5 illustrates an embodiment of an imaging system 500 used to capture and decode images of symbol codes. Imaging system 500 includes imaging camera 200 as an element of the system; the construction and operation of imaging camera 200 is described above in connection with FIGS. 2A-2B, 3A-3B and 4. In addition to imaging camera 200, imaging system 500 includes a signal conditioner 502 coupled to image sensor 208, an analog-to-digital converter 504 coupled to signal conditioner 502, a digital signal processor 506 coupled to analog-to-digital converter 504, and a computer 508 coupled to digital signal processor 506. Although in the illustrated embodiment elements 502-508 are shown as separate from imaging camera 200, in other embodiments one or more of elements 502-508 can be co-housed within housing 202 and thus be an integral part of imaging camera 200. In other embodiments one or more of elements 502-506 can be integrated within image sensor 208.

Signal conditioner 502 is coupled to image sensor 208 to receive and condition analog signals from pixel array 207. In different embodiments, signal conditioner 502 can include various signal conditioning components. Examples of components that can be found in signal conditioner include filters, amplifiers, offset circuits, automatic gain control, etc. Analog-to-digital converter (ADC) 504 is coupled to signal conditioner 502 to receive conditioned signals corresponding to each pixel in pixel array 207 and convert these signals into digital values. Digital signal processor (DSP) 506 can include a processor and memory and is coupled to analog-to-digital converter 504 to receive digitized pixel data from ADC 504 and process the digital data to produce a final digital image and to analyze and decode the final image.

Computer 508 is coupled to DSP 506 to receive the decoded information produced by DSP 506 and to store, display, further process, or otherwise use the decoded information. Among other things, computer 508 can include a processor, memory, storage, one or more displays and hard-wired or wireless connections to one or more other computers or components. In different embodiments, computer 508 can be a personal computer (PC), a mainframe, or an application-specific computer.

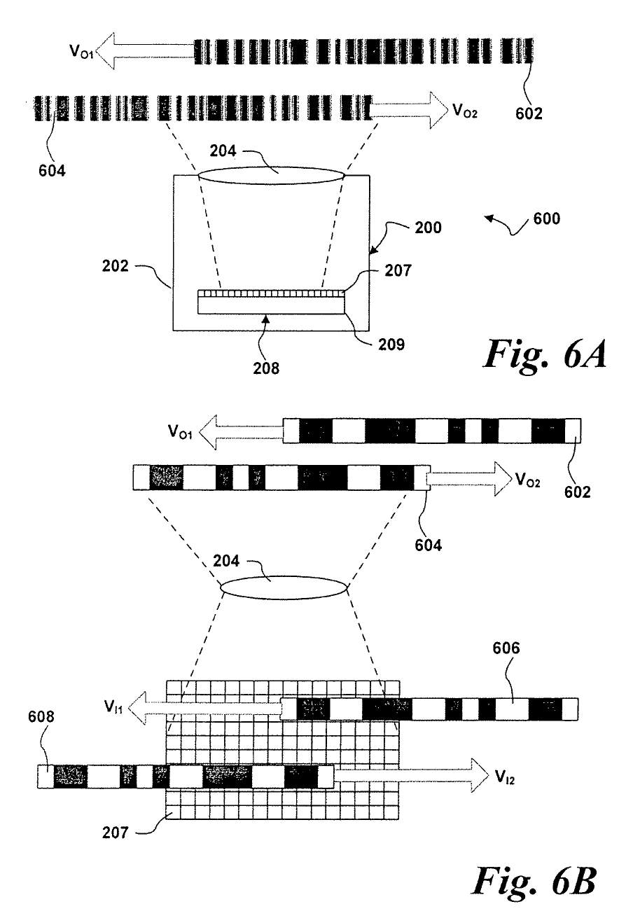

FIGS. 6A-6B together illustrate an embodiment of an imaging camera 200 that can use movement of multiple optical symbol relative to the camera to capture and analyze multiple optical symbols, such as bar codes 602 and 604, that do not fit within the camera's field of view. FIG. 6A illustrates an imaging camera 200, the elements of which are described above in connection with FIG. 2A. An optical symbol such as bar code 602 moves through the field of view of optical element 204 with a speed V_{O1}, such that optical element 204 projects an image of moving bar code 602 onto pixel array 207 of image sensor 208. Simultaneously, another optical symbol such as bar code 604 moves through the field of view of optical element 204 with a speed V_{O2}, such that optical element 204 also projects an image of moving bar code 604 onto pixel array 207 of image sensor 208 (see FIG. 6B, below). Although only two bar codes 602 and 604 are illustrated in the figure, the camera 200 can be used to simultaneously read more or less bar codes than shown.

FIG. 6B illustrates how optical element 204 projects images of bar code 602 and 604 onto pixel array 207. As bar code 602 moves with speed V_{O1} through the field of view of optical element 204, optical element 204 projects an image 606 of bar code 602 onto a plurality of the individual pixels within pixel array 207. Image 606 moves across pixel array 207 with a speed V_{I1} that can depend on various factors, such as the speed V_{O1} of bar code 602 and the exact nature of optical element 204. Similarly, as bar code 604 moves with speed V_{O2} through the field of view of optical element 204, optical element 204 projects an image 608 of bar code 604 onto a plurality of the individual pixels within pixel array 207. Image 608 moves across pixel array 207 with a speed V_{I2} that can depend on various factors, such as the speed V_{O2} of bar code 604 and the exact nature of optical element 204.

Although bar codes 602 and 604 are shown in the figure moving in the same direction as their respective images 606 and 608, in other embodiments the bar codes and their images can move in different directions, depending on factors such as the characteristics of optical element 204. Moreover, although the bar codes 602 and 604 are shown moving substantially parallel to each other, in other embodiments the bar codes can move at some non-zero angle relative to each other (see, e.g., FIG. 8). Similarly, although bar codes 602 and 604 are shown moving in different directions, in other embodiments they can be moving in the same direction.

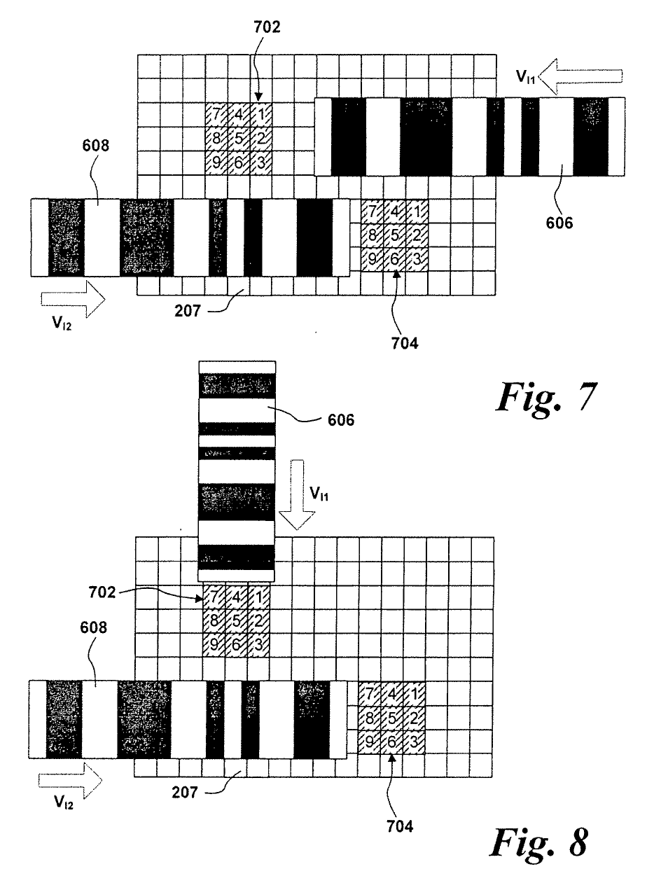

FIG. 7 illustrates an embodiment of bar code images 606 and 608 passing over pixels in pixel array 207. As image 606 moves across a plurality of pixels with speed V_{I1}, the image will move across a subset of pixels 702 within the plurality of pixels on which image 606 is formed. Similarly, as image 608 moves across a plurality of pixels with speed V_{I2}, the image will move across a subset of pixels 704 within the plurality of pixels on which image 608 is formed. Pixel subsets 702 and 704 are shown in the figure as square 3-by-3 arrays with nine pixels numbered 1-9, but as described above in connection with FIGS. 3A and 4A-4D, in other embodiments other pixel subset arrangements can be used.

As images 606 and 608 move over pixel subsets 702 and 704, each pixel 1-9 in each of subsets 702 and 704 can be sampled at a specified rate to capture the information within images 606 and 608. The sampling rate selected for sampling signals from each pixel in each of subsets 702 and 704 will depend on various factors, as described above in connection with FIG. 3A for reading a single bar code but applicable by extension to reading multiple bar codes. In one embodiment the sampling rate selected for pixels within each of subsets 702 and 704 can be the same, but in other embodiments the pixels within subsets 702 and 704 can be sampled at different rates.

FIG. 8 illustrates an alternative embodiment of bar code images 606 and 608 passing over pixels in pixel array 207. As image 606 moves across a plurality of pixels with speed V_{I1}, the image will move across a subset of pixels 702 within the plurality of pixels on which image 606 is formed. Similarly, as image 608 moves across a plurality of pixels with speed V_{I2}, the image will move across a subset of pixels 704 within the plurality of pixels on which image 608 is formed. By contrast to the embodiment shown in FIG. 7, however, in this embodiment the images 606 and 608 are not moving parallel to each other, but rather are moving at a non-zero angle relative to each other. In the illustrated embodiment images 606 and 608 are orthogonal, such that the non-zero angle between them is about 90 degrees, but in other embodiments the non-zero angle can be some value other than 90 degrees. In the illustrated embodiment, pixel subsets 702 and 704 are positioned such that they are not located at the intersection of images 606 and 608.

As images 606 and 608 move over pixel subsets 702 and 704, each pixel 1-9 in each of subsets 702 and 704 can be sampled at a specified rate to capture the information within images 606 and 608. The sampling rate selected for sampling signals from each pixel in each of subsets 702 and 704 will depend on various factors, as described above in connection with FIG. 3A for reading a single bar code but applicable by extension to reading multiple bar codes. In one embodiment the sampling rate selected for pixels within each of subsets 702 and 704 can be the same, but in other embodiments the pixels within subsets 702 and 704 can be sampled at different rates.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
a pixel array to capture an image of a symbol code, wherein the image is formed on a plurality of pixels within the pixel array and is moving relative to the pixel array; and
circuitry and logic coupled to the pixel array to sample a subset of pixels at a selected sampling rate, wherein the subset comprises at least one pixel from among the plurality of pixels on which the image is formed.

2. The apparatus of claim 1 wherein the selected sampling rate is selected based upon one or more of the speed of the moving image, the number of pixels in the subset, the pixel-reading scheme used by the pixel array, and the characteristics of the symbol code.

3. The apparatus of claim 2 wherein the pixel-reading scheme is a rolling shutter.

4. The apparatus of claim 2 wherein the pixel-reading scheme comprises reading individually addressable pixels.

5. The apparatus of claim 1 wherein the subset of pixels comprises an M-by-N array of pixels.

6. The apparatus of claim 5 wherein M is equal to N.

7. The apparatus of claim 1, further comprising circuitry and logic coupled to the pixel array to sample at least one additional subset of pixels at a selected sampling rate, wherein the additional subset comprises at least one pixel from among the plurality of pixels on which an additional image is formed.

8. The apparatus of claim 1 wherein the subset of pixels comprises a group of non-contiguous pixels.

9. A system comprising:
an optical element;
a pixel array optically coupled to the optical element to capture an image of a symbol code moving relative to the optical element, wherein the image is formed on a plurality of pixels within the pixel array and is moving relative to the pixel array; and
circuitry and logic coupled to the pixel array to sample a subset of pixels at a selected sampling rate, wherein the subset comprises at least one pixel from among the plurality of pixels on which the image is formed.

10. The system of claim 9, further comprising a decoder coupled to the circuitry and logic to decode the information sampled from the subset of pixels.

11. The system of claim 9 wherein the selected sampling rate is selected based upon one or more of the speed of the moving image, the number of pixels in the subset, the pixel-reading scheme used by the pixel array, and the characteristics of the symbol code.

12. The system of claim 11 wherein the pixel-reading scheme is a rolling shutter.

13. The system of claim 11 wherein the pixel-reading scheme comprises reading individually addressable pixels.

14. The system of claim 9 wherein the subset of pixels comprises an M-by-N array of pixels.

15. The system of claim 14 wherein M is equal to N.

16. The system of claim 9, further comprising circuitry and logic coupled to the pixel array to sample at least one additional subset of pixels at a selected sampling rate, wherein the additional subset comprises at least one pixel from among the plurality of pixels on which an additional image is formed.

17. The system of claim 9 wherein the subset of pixels comprises a group of non-contiguous pixels.

18. A process comprising:
forming an image of a symbol code on a pixel array, wherein the image is formed on a plurality of pixels within the pixel array and is moving relative to the pixel array; and
sampling a subset of pixels at a selected sampling rate, wherein the subset comprises at least one pixel from among the plurality of pixels on which the image is formed.

19. The process of claim 18 wherein the selected sampling rate is selected based upon one or more of the speed of the moving image, the number of pixels in the subset, the pixel-reading scheme used by the pixel array, and the characteristics of the symbol code.

20. The process of claim 19 wherein the pixel-reading scheme is a rolling shutter.

21. The process of claim 19 wherein the pixel-reading scheme comprises reading individually addressable pixels.

22. The process of claim 18 wherein the subset of pixels comprises an M-by-N array of pixels.

23. The process of claim 22 wherein M is equal to N.

24. The process of claim 18., further comprising sampling at least one additional subset of pixels at a selected sampling rate, wherein the additional subset comprises at least one pixel from among the plurality of pixels on which an additional image is formed.

25. The process of claim 18 wherein the subset of pixels comprises a group of non-contiguous pixels.
